(19) United States
(12) Patent Application Publication
(10) Pub. No.: US 2025/0042647 A1
(43) Pub. Date: Feb. 6, 2025

(54) CAPSULE FOR THE PREPARATION OF A BEVERAGE AND A METHOD FOR MANUFACTURING SAID CAPSULE

(71) Applicant: SOCIETE DES PRODUITS NESTLE S.A., Vevey (CH)

(72) Inventor: DANIEL ABEGGLEN, Grandvaux (CH)

(21) Appl. No.: 18/717,201

(22) PCT Filed: Dec. 5, 2022
(86) PCT No.: PCT/EP2022/084401

§ 371 Date: Jun. 6, 2024

(30) Foreign Application Priority Data
Dec. 8, 2021 (EP) 21213086.8

(51) Int. Cl. B65D 85/804; B32B 1/00; B32B 3/02; B32B 3/30; B32B 27/08; B32B 27/10; B32B 27/32; B32B 29/06; B65D 65/46; D21J 1/08; D21J 1/12; D21J 7/00

(52) U.S. Cl. CPC B65D 85/8046; B32B 1/00; B32B 3/02; B32B 3/30; B32B 27/08; B32B 27/10; B32B 27/32; B32B 29/06; B65D 65/466; B65D 85/8049; D21J 1/08; D21J 1/12; D21J 7/00; B32B 2307/58; B32B 2307/722; B32B 2307/7244; B32B 2439/02; B32B 2439/70; B65D 2565/387

(57) ABSTRACT

A capsule for the preparation of a beverage in a beverage preparation device (10), comprising: a cup-shaped body (1) with a bottom wall (4), a lateral wall (5) and a flange (3), and a cover (2) sealed onto the flange (3) for closing the cup-shaped body (1), wherein said bottom wall (4) comprises at least a fluid injection portion (7), suitable for being pierced by a piercing member (12) of the beverage preparation device (10), and at least a surrounding portion (13A, 13B) surrounding said first fluid injection portion (7); wherein the cup-shaped body (1) comprises a cellulose pulp layer (14), and an oxygen barrier liner (15) attached to said cellulose pulp layer (14); wherein the thickness (T1) of said fluid injection portion (7) is less than the thickness (T2) of said at least a surrounding portion (13A, 13B), and wherein the density of at least the cellulose pulp layer (14) of said fluid injection portion (7) having reduced thickness is increased with respect to the density of the cellulose pulp of said surrounding portion (13A, 13B); such as to improve the piercing of said fluid injection portion by the piercing member and to increase the stiffness of this fluid injection portion with respect to the stiffness of said surrounding portion (13A, 13B).

### FIELD OF THE INVENTION

The present invention concerns a capsule for the preparation of a beverage in a beverage preparation device and a method for manufacturing said capsule. The capsule comprises a cup-shaped body, wherein at least said body is shaped from a cellulose pulp-based material.

### BACKGROUND OF THE INVENTION

Containers or capsules made from a cellulose pulp-based material are known in the field of beverage preparation devices. Cellulose pulp-based materials are also known which are capable of maintaining the qualities of the beverage substance in the capsule, at least for a certain period of time. Single-use capsules for preparing a beverage in a beverage production device are also known.

These cellulose pulp-based single-use capsules provide a potential reduced environmental impact compared to capsules made of other materials.

Known cellulose pulp-based capsules used in beverage preparation devices typically comprise a member enclosing the capsule during the beverage preparation process and the injection of water in the capsule for the preparation of the beverage.

In known paper capsules, it can happen that when the water injection member has to pierce the dedicated portion of the cup-shaped body of the capsule, this dedicated portion of the cup-shaped body, and often also the entire cup-shaped body, does not retain its shape and for example it collapses inwards.

This can cause the injection member not to pierce the wall of the cup-shaped body or only partly pierce it. This can, in some cases, block the capsule inside the beverage preparation device and/or cause an incorrect injection of the water and consequently an incorrect dispensing of the beverage.

The present invention aims to improve the capability of the cup-shaped body of capsules made of cellulose pulp-based materials to be pierced by the known piercing elements of a common beverage preparation device.

### SUMMARY OF THE INVENTION

The invention as claimed in claim 1 is a capsule for the preparation of a beverage in a beverage preparation device, comprising: a cup-shaped body with a bottom wall, a lateral wall and a flange, and a cover sealed onto the flange for closing the cup-shaped body; the bottom wall comprises at least a fluid injection portion, suitable for being pierced by a piercing member of the beverage preparation device, and at least a surrounding portion surrounding said first fluid injection portion; and the cup-shaped body comprises a cellulose pulp layer, and an oxygen barrier liner attached to said cellulose pulp layer.

According to the invention the thickness of the fluid injection portion is less than the thickness of the at least a surrounding portion and the density of at least the cellulose pulp layer of the fluid injection portion having reduced thickness is increased with respect to the density of the cellulose pulp of said surrounding portion.

The invention improves the piercing of the fluid injection portion by the piercing member.

The invention also increases the stiffness of the fluid injection portion with respect to the stiffness of the surrounding portions or portion and this also cooperate in improving the piercing of the fluid injection portion by the piercing member.

In a preferred embodiment of the invention, the thickness of the fluid injection portion is decreased by 10%-80%, preferably by 50%, with respect to the thickness of the surrounding portions or portion.

According to another preferred embodiment, only the thickness of the cellulose pulp layer of the fluid injection portion is less than the thickness of the cellulose pulp layer of the surrounding portions or portion, the thickness of the oxygen barrier liner remaining the same both in the fluid injection portion and in the surrounding portions or portion.

According to another preferred embodiment, the thickness of the cellulose pulp layer and the thickness of the oxygen barrier liner of said fluid injection portion is less than the thickness of the cellulose pulp layer and the thickness of the oxygen barrier liner of the surrounding portions or portion.

According to a further preferred embodiment, the density of the fluid injection portion is greater that the density of the surrounding portions or portion, preferably the density of the fluid injection portion is increased by 0.1%-20%, more preferably by 5%-10%, with respect to the density of said of surrounding portions or portion at least.

Preferably, the cup-shaped body is made of cellulose pulp comprising cellulose fibres in a percentage ranging from 80% to 100% by weight.

Preferably, the oxygen barrier liner comprises a thermoformable polymer.

Preferably but not exclusively, the capsule of the invention is a single use coffee capsule.

According to the invention, the use of a capsule as described before in a beverage preparation device is also disclosed.

The invention also relates to a method for manufacturing a capsule as disclosed above, wherein said capsule comprises: a cup-shaped body, with a bottom wall, a lateral wall and a flange, a cover sealed onto the flange for closing the cup-shaped body,
wherein the bottom wall comprises: at least a fluid injection portion, suitable for being pierced by a piercing member of the beverage preparation device, and at least a surrounding portion surrounding said first fluid injection portion;
wherein the cup-shaped body comprises a cellulose pulp layer made of cellulose pulp, and an oxygen barrier liner attached to said cellulose pulp layer;
wherein the cup-shaped body of the capsule is obtained by moulding in a mould a dry or wet, preferably wet, cellulose pulp, and by attaching the oxygen barrier liner to the moulded cellulose pulp layer.
   According to the invention the method comprises a step wherein the thickness of said fluid injection portion of the capsule is decreased with respect to the thickness of the surrounding portions or portion such as to improve the piercing of said fluid injection portion by the piercing member and to increase the stiffness of this fluid injection portion with respect to the stiffness of the surrounding portions or portion; wherein said thickness decreasing is made during the moulding process of the cup-shaped body or in a successive step by applying: a local mechanical compression only to the cellulose pulp layer of said injection portion, or to both said cellulose pulp layer and the oxygen barrier liner of said injection portion.

Preferably, in addition to the local mechanical compression, also an ultrasonic stiffening treatment is applied to the cellulose pulp layer of the of the injection portion.

Preferably, a heating treatment is applied to the oxygen barrier liner and the cellulose pulp layer of the injection portion.

In the context of the invention, the term “cellulose pulp” refers to a pulp comprising cellulose fibres in a percentage ranging from 80% to 100% by weight.

The term “cellulose fibres” refers to fibres having a wood and/or a wood free origin. The fibres, by way of non-limiting examples, are: hard wood cellulose fibres, soft wood cellulose fibres, wheat fibres, corn fibres, bagasse fibres, bamboo fibres, hemp fibres, cotton fibres, other similar vegetable or plant fibres, or a combination thereof.

The cup-shaped body made of cellulose pulp comprises at least one oxygen barrier liner made of one, preferably several layers.

The oxygen barrier liner is made of a known mono- or multi-layer polymeric liner, comprising for example a polymer of fossil or non-fossil origin, or a BioSource polymer, and is attached to the inner surface of the cellulose pulp cup-shaped body of the capsule.

A preferred multilayer barrier liner comprises a core layer having oxygen and/or moisture barrier properties, surrounded by a sealing layer for sealing said barrier liner to the cellulose pulp material.

The oxygen barrier liner, by way of non-limiting examples, comprises one or more of following layers:
an outermost polymeric layer comprising a biodegradable polymer selected within the list of: polybutylene succinate (PBSA/bioPBS), polybutylene adipate terephthalate (PBAT), starch, cellulose derivates, polylactic acid (PLA), polyhydroxyalcanoates (PHA), or a combination thereof;
a first tie layer comprising a biodegradable modified or functionalized polyolefin;
a barrier layer comprising a polymer selected within the list of: butenediol vinyl alcohol copolymer (BVOH), polyvinyl alcohol (PVOH) or a combination thereof;
a second tie layer comprising a biodegradable modified or functionalized polyolefin;
an innermost polymeric layer comprising a biodegradable polymer selected within the list of: polybutylene succinate (PBSA), polybutylene adipate terephthalate (PBAT), starch, cellulose derivates, polylactic acid (PLA), polyhydroxyalcanoates (PHA) or a combination thereof.

The cover is made in a known material, preferably it is a polymeric film membrane.

The cover may be flat, i.e., non-formed in a three-dimensional shape.

The cover is sealed onto a sealing layer of the cup-shaped body opening, in order to close it after filling with an ingredient.

The cup-shaped body of the capsule is preferably obtained by moulding in a mould a dry or wet, preferably wet, cellulose pulp.

Preferably, after the cup-shaped body of the capsule is moulded, the “barrier liner” mentioned above is laminated on the inside and/or outside surface of said body.

Preferably, the barrier to oxygen for both the cover and the cup-shaped body is selected to provide a sufficient shelf life depending on the nature of the beverage ingredients. For coffee, for example, the shelf life expected may be of 12 months.

Preferably, the cup-shaped body, its oxygen barrier liner and/or the cover are made of home compostable materials, so that it is possible to throw the capsules or at least part of it in the household compostable waste.

Preferably, the cellulose layer of the cup-shaped body, its oxygen barrier liner and/or the cover of the capsule are made of home compostable materials. The capsules according to the invention are normally meant to be recycled in recycling processes that are organized at official recycling facilities according to national regulations (for instance in paper recycling streams, or in general garbage recycling or treatment streams). However, in case the capsule is placed in nature, in a household compostable waste or in a landfill, said capsules are designed with materials that are naturally ready to be degraded by bacteria and in conditions of temperature and humidity that are naturally present in nature. In this way, it is ensured that such capsules will not stay in nature and will naturally disappear within a short period of time (a few weeks in principle) within the conditions defined by home composability standards. More precisely, home composability is now well defined on a national level and mainly based on international standard EN 13432; therefore, they do not require to be further defined in-depth in the present specification. Materials or products compliant with these standards can be recognized by a conformity mark stating their home composability. Some examples of home composability certifications at a national level include, but are not limited to, the following. The certifier TÜV AUSTRIA BELGIUM offers such a home composability certification scheme, and DIN CERTCO offers a certification for home composability according to the Australian standard AS 5810. Italy has a national standard for composting at ambient temperature, UNI 11183:2006. In November 2015, the French Standard “NF T 51-800 Plastics-Specifications for plastics suitable for home composting” was introduced. This standard is covered in the DIN CERTCO scheme.

The preparation of the beverage is obtained by mixing of the fluid substance with an ingredient contained in the capsule. Preferably, the ingredients are chosen within the list of roast and ground coffee, compacted or not, soluble powder coffee or leaf tea. Dairy ingredients (e.g., milk or creamer) could also be provided, as well as chocolate, fruit juices, soups, vegetable juices, bouillons, smoothies, purees, coulis, creams, chicory, barley, culinary aid, soup ingredient, infant formula or a combination thereof, in powdered soluble form, liquid concentrated form having various viscosities or in gel form.

Most preferably, the beverage ingredients are roast and ground coffee.

The capsule of the invention may typically interact with a beverage and/or food preparation device, such as by being fed with a diluent (e.g., hot, cold or ambient water) in the container; such diluent mixes, or interacts otherwise, with the beverage ingredients. With the expression “mixing of the diluent with the beverage ingredient(s)” it should be intended that all the ingredients contained in the capsule are in a form which is compatible with a generic mixing operation (dissolution, extraction or infusion) with the diluent to obtain the beverage product. Devices of this type are for example those used for the extraction of traditional Nespresso® capsules.

Preferably, the cavity delimited by the capsule body and the cover of the capsule is essential oxygen-free and the empty space is saturated with an inert gas such as nitrogen, carbon oxide and combinations thereof. Preferably, the capsule has an internal pressure of gas above atmospheric pressure, due to the gas contained in the coffee and emanating in the cavity after sealing, such as carbon oxide and dioxide.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a perspective view of a capsule according to the present invention;

FIG. 2 is a schematic longitudinal sectional view of the capsule of FIG. 1;

FIG. 3 is a schematic enlarged view of the portion of FIG. 2 indicated by the arrow W1;

FIG. 4 is a schematic enlarged sectional view similar to FIG. 3, but showing a second manufacturing method of the same components shown in FIG. 3;

FIG. 5 is a schematic and partial longitudinal sectional view of the capsule of FIG. 1 when it is enclosed in a capsule enclosing member of a beverage preparation device;

FIG. 6 is a schematic and partial longitudinal sectional view of the capsule of FIG. 1 in an intermediate step of a first manufacturing method;

FIG. 6A is a schematic enlarged view of the portion of FIG. 6 indicated by the arrow W2;

FIG. 7 is a schematic and partial longitudinal sectional view of the capsule of FIG. 1 in an intermediate step of a second manufacturing method; and

FIG. 8 is a schematic and partial longitudinal sectional view of the capsule of FIG. 1 in an intermediate step of a third manufacturing method.

### DETAILED DESCRIPTION OF THE INVENTION

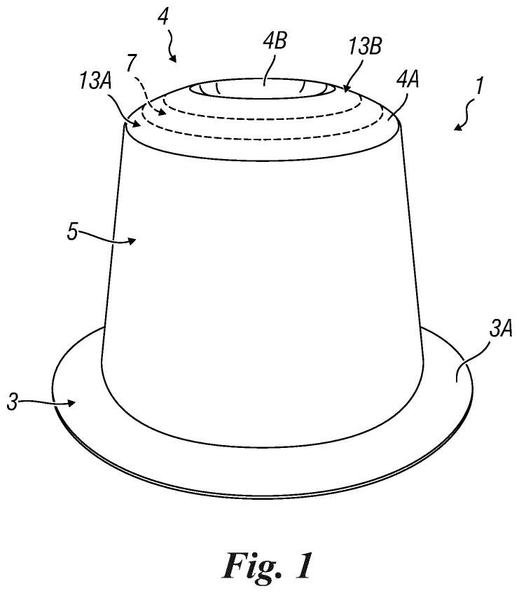

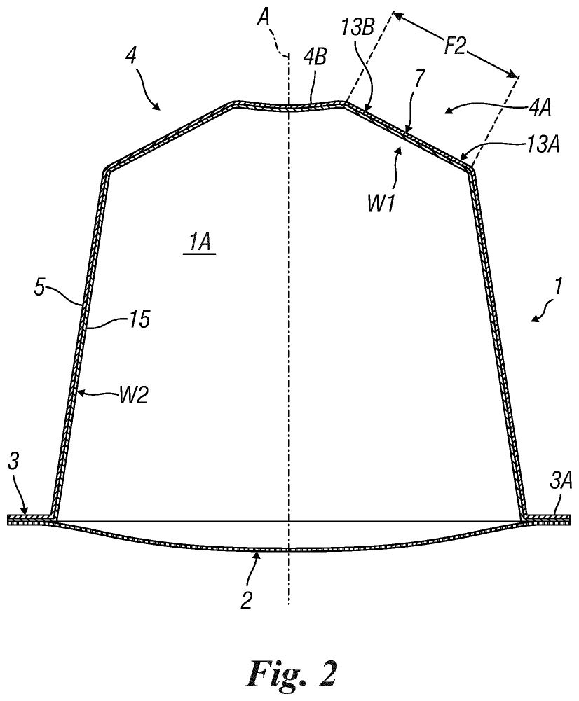

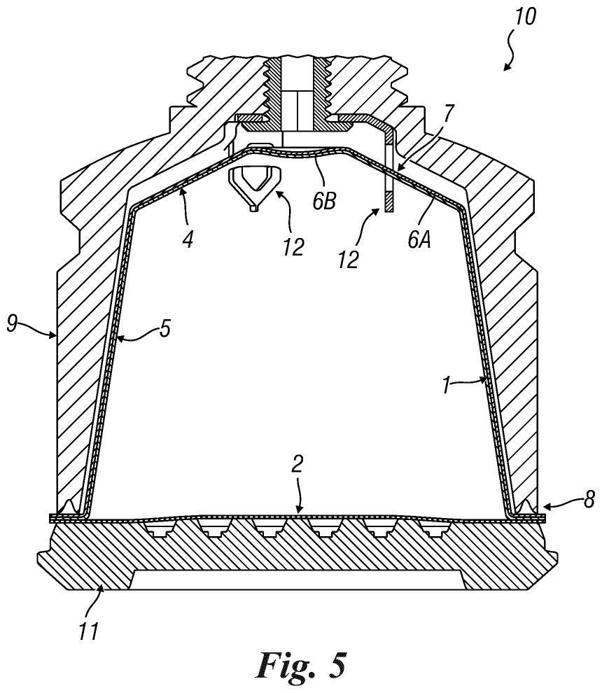

FIGS. 1 and 2 show a capsule for the preparation of a beverage in a beverage preparation device 10, comprising: a cup-shaped body 1, a cover 2 for closing the cup-shaped body 1, and an annular flange 3 for the cover 2 to seal thereon. The cup-shaped body 1 comprises: a bottom wall 4, a lateral wall 5 and the flange 3. The bottom wall 4 comprises: at least a fluid injection portion 7, suitable for being pierced by a piercing member 12 (shown in FIG. 5) of the beverage preparation device 10, and at least a surrounding portion 13A, 13B surrounding said first fluid injection portion 7 (in FIG. 1 and FIG. 2 two surrounding portions 13A, 13B are shown). The cup-shaped body 1 comprises a cellulose pulp layer 14, made of cellulose pulp, and an oxygen barrier liner 15 attached to said cellulose pulp layer 14.

According to the invention, the thickness T1 of said fluid injection portion 7 is less than the thickness T2 of the surrounding portions 13A, 13B, and the density of at least the cellulose pulp layer 14 of said fluid injection portion 7 having reduced thickness is increased with respect to the density of the cellulose pulp of said surrounding portions.

In a capsule according to the invention the piercing of the fluid injection portion 7 by the piercing member 12 is improved.

In a capsule according to the invention, the stiffness of the fluid injection portion 7 is increased with respect to the stiffness of the surrounding portions 13A, 13B and this also cooperate in improving the piercing of the fluid injection portion 7 by the piercing member 12.

Preferably, the thickness T1 of the fluid injection portion 7 is decreased by 10%-80%, more preferably by about 50%, with respect to the thickness T2 of the surrounding portions 13A, 13B.

In a preferred embodiment of the invention, the stiffness of the fluid injection portion is increased by 1%-50%, preferably by 20%, with respect to the thickness of the surrounding portions or portion.

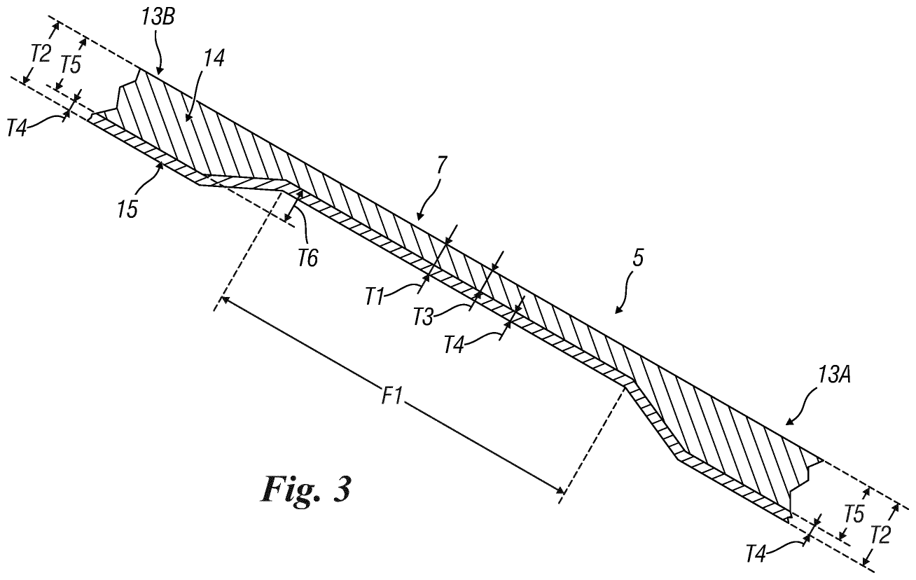

As shown in FIG. 3, preferably only the thickness T3 of the cellulose pulp layer 14 of the fluid injection portion 7 is decreased, and is less than the thickness T5 of the cellulose pulp layer 14 of the surrounding portions 13A, 13B, while the thickness T4 of the oxygen barrier liner 15 remains the same both in the fluid injection portion 7 and in the surrounding portions 13A, 13B.

Preferably, as shown in FIGS. 1 and 3, the external surface of the bottom wall 4, both at the injection portion 7 and at the surrounding portions 13A, 13B, is a uniform, smooth and free of discontinuity surface, since the thickness reduction is provided at the internal surface of the injection portion 7.

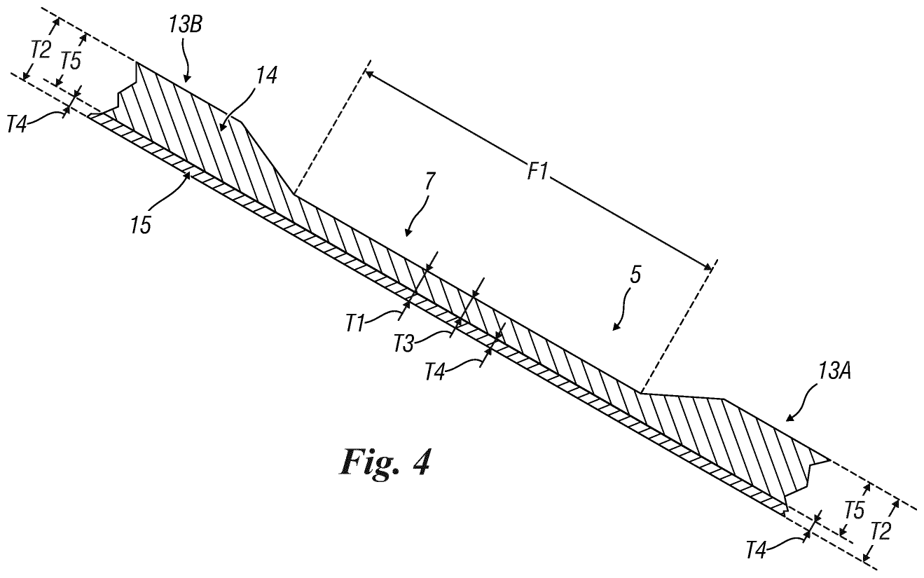

According to the embodiment shown in FIG. 4, the injection portion 7 with reduced thickness is formed from the outside of the cavity 1A delimited by the cup-shaped body 1. The features of this injection portion 7 formed from the outside are the same as those discussed before with reference to FIG. 3 and will not be repeated. As shown in FIG. 4, the external surface of the bottom wall 4 at the injection portion 7 comprise a sunken part and comprises a discontinuity.

Preferably, also the density D1 of the fluid injection portion 7 is greater that the density D2 of the surrounding portions 13A, 13B. Preferably, the density D1 of the fluid injection portion 7 is increased by 0.1%-20%, more preferably by 5%-10%, with respect to the density D2 of the surrounding portions 13A, 13B.

The cup-shaped body 1 is preferably revolutionary symmetrical. Preferably, the lateral wall 5 has a frustoconical shape, with a circular cross section and with an increasing diameter towards the annular flange 3.

Preferably, the lateral wall 5, when seen in a longitudinal section, is inclined with respect to a longitudinal axis A of the cup-shaped body 1.

The bottom wall 4 preferably comprises a first inclined wall 4A and a second wall 4B, so as to delimit a shallow concave volume. The first inclined wall 4A preferably has a frustoconical shape, with a circular cross section and with an increasing diameter towards the wall 5. The second wall 4B is preferably flat or convex (from the point of view of the cavity 1A, i.e., protruding intern towards the cavity 1A) as shown in FIG. 2. As already mentioned above the bottom wall 4 of the cup-shaped body 1, and preferably its inclined wall 4A comprises the fluid injection portion 7 (whose area has been highlighted with a dashed line in FIG. 1) suitable for being pierced by the piercing members 12 of the beverage device 10 for the preparation of the beverage (as shown in FIG. 5). This fluid injection portion 7 has preferably an annular shape and has a width F1 (FIG. 2) which is comprised between 10% and 100% of the width F2 of the inclined wall 4A. The fluid injection portion 7 is surrounded by portions 13A, 13B of the bottom wall 4 of the cup which are preferably annular shaped parts of the inclined wall 4A. In an alternative embodiment (not shown), the fluid injection portion can be provided in the end wall 4B of the bottom wall 4 of the cup-shaped body 1, for example in the center of the end wall 4B. In a further alternative embodiment (not shown), the bottom wall 4 of the cup-shaped body 1 comprises a plurality of injection portions separated one from another.

It is to be noted that the fluid injection portion may have any suitable shape different from the annular one disclosed in the drawings.

In an alternative embodiment, not disclosed in the drawings, the fluid injection portion having a reduced thickness may extend over the entire inclined wall 4A or even over the entire bottom wall 4.

The annular flange 3 comprises a preferably flat wall 3A.

The beverage preparation device 10, partially disclosed in FIG. 3, comprises, as usual for the skilled person, a movable enclosing member 9 and a support plate 11 for supporting the cover 2 of the capsule. This support plate 11 tears off the cover 2 and allows the beverage to flow out of the capsule when the liquid injected into the capsule by the piercing members 12 creates a predetermined pressure in the capsule.

As usual for the skilled person, the enclosing member 9 is movable from an initial position (not shown), which allows the introduction of the capsule in the beverage preparation device, and a brewing position (shown in FIG. 3), wherein the enclosing member 9 and the support plate 11 tightly enclose the capsule. In this position pressurized liquid is injected into the capsule through openings formed by one or more pointed piercing members 12 of the beverage preparation device 10.

These pointed piercing members 12 are designed for piercing the bottom wall 4 of the cup-shaped body 1 at the injection portion 7 of this wall.

The operation of the beverage preparation device 10, as well as the technical features of its various components, are well known to the skilled person and therefore will not be described in detail.

As discussed before, the cup-shaped body 1 is made of cellulose pulp comprising cellulose fibres in a percentage ranging from 80% to 100% by weight.

The term “cellulose fibres” refers to fibres having a wood and/or a wood free origin. The fibres, by way of non-limiting examples, are: hard wood cellulose fibres, soft wood cellulose fibres, wheat fibres, corn fibres, bagasse fibres, bamboo fibres, hemp fibres, cotton fibres, other similar vegetable or plant fibres, or a combination thereof.

A preferred oxygen barrier liner 15 comprises a thermoformable polymer.

Preferably, the oxygen barrier liner 15 is made of at least one layer and, more preferably, of several layers.

Preferably, the oxygen barrier liner 15 comprises a core layer having oxygen and/or moisture barrier properties, surrounded by a sealing layer for sealing said barrier liner to the cellulose pulp material.

Preferably, the multilayer barrier liner comprises a core layer having oxygen and/or moisture barrier properties, surrounded by sealing layers for sealing said barrier liner onto the cellulose pulp.

Preferably, the barrier liner 15 is provided at all the inner surfaces of the cup-shaped body 1, such as to delimit at least the entire cavity 1A for housing the beverage substance.

The oxygen barrier liner 15 is made of a known mono- or multi-layer polymeric liner, comprising for example a polymer of fossil or non-fossil origin, or a BioSource polymer, and is attached to the inner surface of the cellulose pulp cup-shaped body of the capsule.

The oxygen barrier liner, by way of non-limiting examples, comprises one or more of following layers:
an outermost polymeric layer comprising a biodegradable polymer selected within the list of: polybutylene succinate (PBSA/bioPBS), polybutylene adipate terephthalate (PBAT), starch, cellulose derivates, polylactic acid (PLA), polyhydroxyalcanoates (PHA), or a combination thereof;
a first tie layer comprising a biodegradable modified or functionalized polyolefin;
a barrier layer comprising a polymer selected within the list of: butenediol vinyl alcohol copolymer (BVOH), polyvinyl alcohol (PVOH) or a combination thereof;
a second tie layer comprising a biodegradable modified or functionalized polyolefin;
an innermost polymeric layer comprising a biodegradable polymer selected within the list of: polybutylene succinate (PBSA), polybutylene adipate terephthalate (PBAT), starch, cellulose derivates, polylactic acid (PLA), polyhydroxyalcanoates (PHA) or a combination thereof.

Preferably, the first and outermost polymeric layer has a thickness comprised between μm 10 and 50 μm, and said layer has an elongation at break comprised between 10% and 800%, a melt flow rate (MFR) comprised between 2 and 4 when measured at 150° C. during 10 minutes with a pressure of 2.16 kg, and said layer has a melting point temperature below 80° C.

Preferably, the first tie layer has melting point temperature comprised between 180° C. and 230° C. and a thickness comprised between 1 μm and 12μ m.

Preferably, the barrier layer has a melting point temperature comprised between 180° C. and 230° C. and a thickness comprised between 1 μm and 15 μm.

Preferably, the second tie layer has a melting point temperature comprised between 180° C. and 230° C. and a thickness comprised between 1 μm and 10 μm.

Preferably, the innermost polymeric layer has a thickness comprised between 10 μm and 50 μm, and said innermost layer has an elongation at break comprised between 10% and 1000%, a melt flow rate (MFR) comprised between 4 and 10 when measured at 190° C. during 10 minutes with a pressure of 2.16 kg, and said layer has a melting point temperature comprised between 110° C. and 180° C.

The cover 2 is made in a known material. Preferably, said cover 2 is a polymeric film membrane.

The cover 2 may be flat, i.e., non-formed in a three-dimensional shape.

The cover 2 preferably comprises an oxygen barrier layer.

Preferably, the cellulose layer 14 of the cup-shaped body 1, its oxygen barrier liner 15 and/or the cover 2 are made of home compostable materials. The capsules according to the invention are normally meant to be recycled in recycling processes that are organized at official recycling facilities according to national regulations (for instance in paper recycling streams, or in general garbage recycling or treatment streams). However, in case the capsule is placed in nature, in a household compostable waste or in a landfill, said capsules are designed with materials that are naturally ready to be degraded by bacteria and in conditions of temperature and humidity that are naturally present in nature. In this way, it is ensured that such capsules will not stay in nature and will naturally disappear within a short period of time (a few weeks in principle) within the conditions defined by home composability standards. More precisely, home composability is now well defined on a national level and mainly based on international standard EN 13432; therefore, they do not require to be further defined in-depth in the present specification. Materials or products compliant with these standards can be recognized by a conformity mark stating their home composability. Some examples of home composability certifications at a national level include, but are not limited to, the following. The certifier TUV AUSTRIA BELGIUM offers such a home composability certification scheme, and DIN CERTCO offers a certification for home composability according to the Australian standard AS 5810. Italy has a national standard for composting at ambient temperature, UNI 11183:2006. In November 2015, the French Standard “NF T 51-800 Plastics-Specifications for plastics suitable for home composting” was introduced. This standard is covered in the DIN CERTCO scheme.

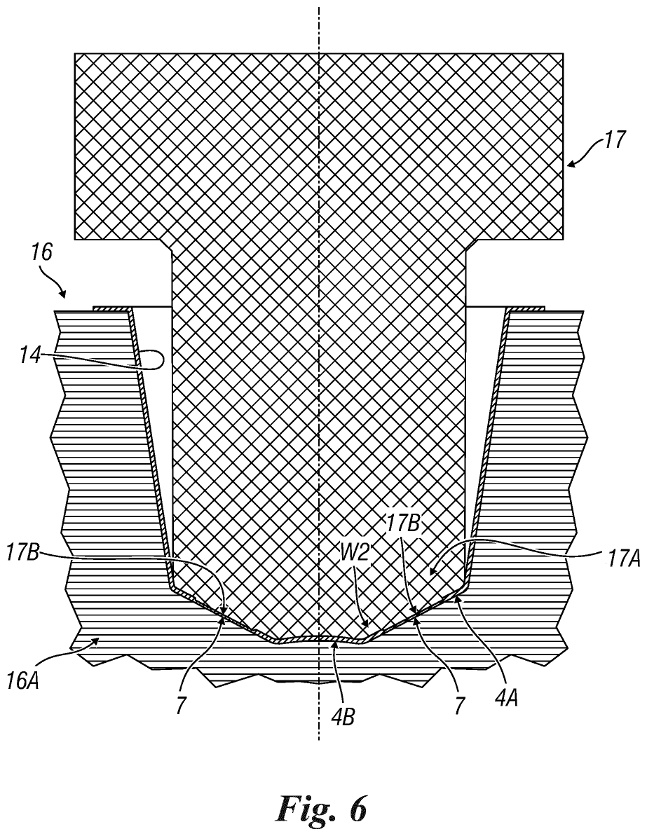

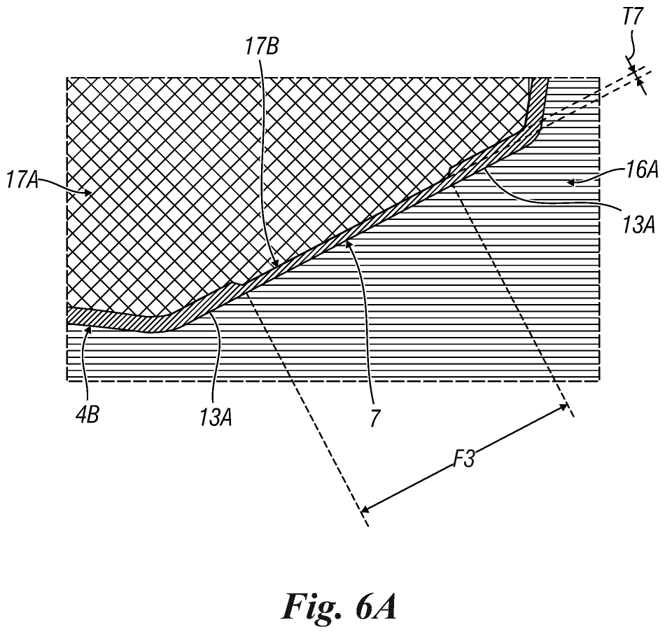

According to the invention, the cup-shaped body 1 of the capsule is preferably obtained by moulding in a mould 16 (FIG. 6) a dry or wet, preferably wet, cellulose pulp.

The moulding process is usual for the skilled person and will not be further described in detail.

Preferably, by this moulding process only the cellulose pulp layer 14 of the cup-shaped body 1 is made.

After the cellulose pulp layer 14 of the cup-shaped body 1 is made, and preferably when the cellulose pulp is dry, the oxygen barrier liner 15 is attached to the inner surface of the cup-shaped body portions of this cellulose pulp layer 14. Preferably the oxygen barrier liner 14 is attached by thermoforming it to the inner surface of the cup-shaped body 1.

The cellulose pulp mould 16 comprises a female part 16A and a complementary shaped male part (not shown in FIG. 6). The cup-shaped body 1 made with the mould has a substantially uniform thickness.

The injection portion 7 with reduced thickness can be obtained according to different methods.

According to a first method (shown in FIG. 6) the injection portion 7 is made by local mechanical compression. According to this method, after the cellulose pulp layer 14 of the cup-shaped body 1 is made, and preferably when the cellulose pulp is still wet, a pressing tool 17 is inserted in the female part 16A of the mould and is pressed against the inner surface of the bottom wall 4 of the cup-shaped body 1, so as to form the injection portion 7 of reduced thickness in the bottom wall.

This pressing tool 17 comprises a head 17A having the same shape as that of the bottom wall 4, so that the external surface of this head 17A comes into contact with the corresponding internal surface of the bottom wall 4. For forming the injection portion 7, the head 17A comprises a protruding portion 17B (FIG. 6A having a shape and a width F3 identical to that of the injection portion 7 and which has a thickness T7 (FIG. 6A) equal to the desired reduction in the thickness of the inclined wall 4A of the bottom wall 4.

By way of non-limiting example, the compression load applied by the pressing tool 17 is comprised between 1000 N and 5000 N and is applied preferably for a period of time comprised between 0.1 seconds and 1 second, preferably about 0.3 seconds.

According to this first manufacturing method, the oxygen barrier liner 15 is attached to the inner surface of the cup-shaped body 1 after the reduced thickness injection portion 7 has been formed.

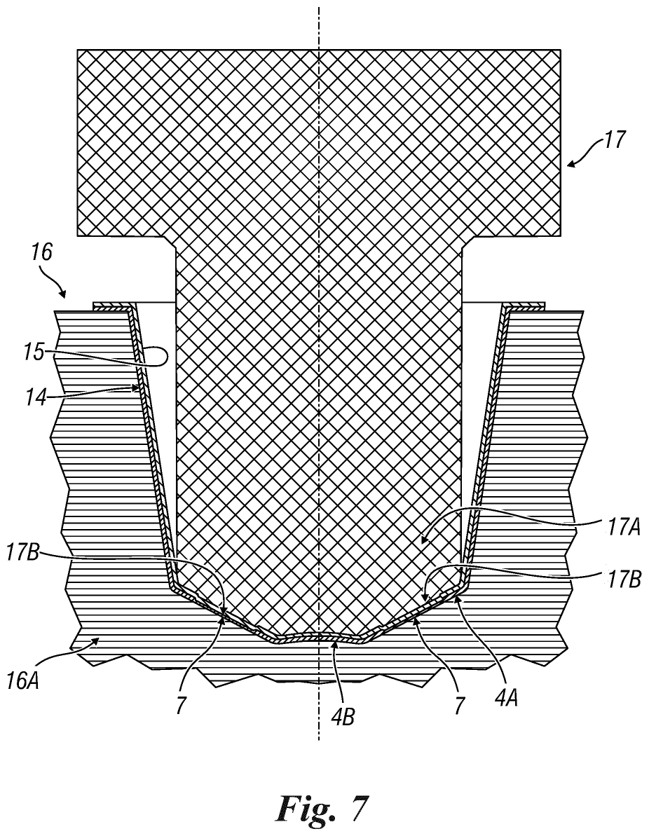

According to a second manufacturing method (shown in FIG. 7), the injection portion 7 is still made by applying local mechanical compression, but the oxygen barrier liner 15 is attached to the inner surface of the cup-shaped body 1, before the injection portion 7 with a reduced thickness is formed, and the latter is then formed with a pressing tool 17 identical to the one described above.

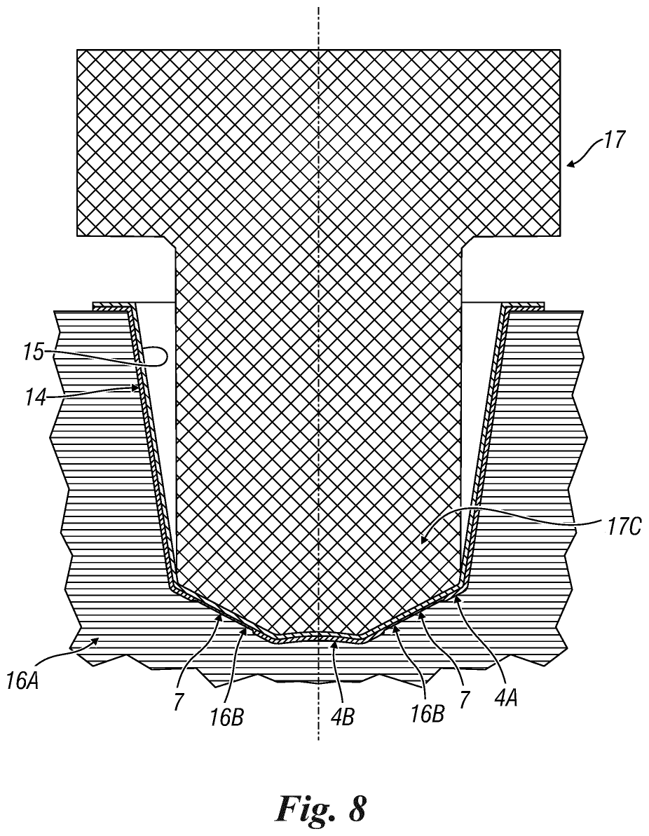

As shown in FIG. 8, the injection portion 7 with reduced thickness can still be formed by applying local mechanical compression, but is formed from the outside of the cavity 1A delimited by the cup-shaped body 1. The shape of this injection portion 7 formed from the outside is shown in FIG. 4 and has been previously discussed.

To reduce the thickness of the injection portion 7 from the outside, a third manufacturing method is implemented. This manufacturing method comprises:
a) providing the mould 16 with a female part 16A comprising, in its portion forming the bottom wall 4, a projection 16B dimensioned and shaped identically to the injection portion 7 and which has a thickness equal to the desired reduction in the thickness of the inclined wall 4A of the bottom wall 4; and
b) providing a pressing tool 17 comprising a head 17C having exactly the same shape as that of the bottom wall 4, so that the external surface of this head 17C comes into contact with the corresponding internal surface of the bottom wall 4, and presses it against the corresponding walls of the female part 16A of the mould and against the projection 16B, for forming the injection portion 7 with reduced thickness (shown in FIG. 4).

Preferably, this third method for forming the injection portion 7 is implemented after the oxygen barrier liner 15 has been attached to the inner surface of the cup-shaped body 1, so that the attachment of this liner 15 is increased.

Further manufacturing methods are possible. For example, the injection portion 7 with reduced thickness can be directly moulded during the cellulose pulp moulding process for forming the cup-shaped body 1 without the need to apply local mechanical compression.

In order to further increase the stiffness and the density of the injection portion 7, the pressing tool can comprise, in addition to the projection suitable for applying a local mechanical compression, also means for applying an ultrasonic treatment to the cellulose pulp of the injection portion.

In order to further increase the attachment of the oxygen barrier liner 15 to the injection portion 7, the pressing tool can comprise, in addition to the projection suitable for applying a local mechanical compression, also means for heating the oxygen barrier liner 15 and the cellulose pulp of the injection portion 7.

It should be understood that various changes and modifications to the presently preferred embodiment of the capsule described herein will be apparent to those skilled in the art. Such changes and modifications can be made without departing from the scope of the present invention covered by the appended claims. For example, the cup-shaped body and/or the fluid injection portion may have a different shape.

1. A capsule for the preparation of a beverage in a beverage preparation device, comprising: a cup-shaped body with a bottom wall, a lateral wall and a flange, and a cover sealed onto the flange for closing the cup-shaped body, wherein:
said bottom wall comprises at least a fluid injection portion, suitable for being pierced by a piercing member of the beverage preparation device, and at least a surrounding portion surrounding said first fluid injection portion;
the cup-shaped body comprises a cellulose pulp layer, and an oxygen barrier liner attached to said cellulose pulp layer;
the thickness (T1) of said fluid injection portion is less than the thickness (T2) of said at least a surrounding portion,
the density of at least the cellulose pulp layer of said fluid injection portion having reduced thickness is increased with respect to the density of the cellulose pulp of said surrounding portion,
such as to improve the piercing of said fluid injection portion by the piercing member and to increase the stiffness of this fluid injection portion with respect to the stiffness of said surrounding portion.

2. The capsule according to claim 1, wherein the thickness of said fluid injection portion is decreased by 10%-80% with respect to the thickness of said at least a surrounding portion.

3. The capsule according to claim 1, wherein:
only the thickness of the cellulose pulp layer of the fluid injection portion is less than the thickness of the cellulose pulp layer of said at least a surrounding portion, the thickness of the oxygen barrier liner remaining the same both in the fluid injection portion and in said at least a surrounding portion; and
the thickness of the cellulose pulp layer and the thickness of the oxygen barrier liner of said fluid injection portion is less than the thickness of the cellulose pulp layer and the thickness of the oxygen barrier liner of said at least a surrounding portion.

4. The capsule according to claim 1, wherein the density (D1) of the fluid injection portion is greater that the density (D2) of said at least a surrounding portion.

5. The capsule according to claim 1, wherein the cup-shaped body is made of cellulose pulp comprising cellulose fibres ranging from 80% to 100% by weight.

6. The capsule according to claim 1, wherein the oxygen barrier liner comprises a thermoformable polymer.

7. The capsule according to claim 1, wherein the cellulose layer of the cup-shaped body, its oxygen barrier liner and the cover are made of home compostable materials.

8. The capsule according to claim 1, wherein said capsule is a single use coffee capsule.

9. (canceled)

10. A method for manufacturing a capsule, wherein said capsule comprises: a cup-shaped body, with a bottom wall, a lateral wall and a flange, and a cover sealed onto the flange for closing the cup-shaped body,
wherein the bottom wall comprises: at least a fluid injection portion, suitable for being pierced by a piercing member of the beverage preparation device, and at least a surrounding portion surrounding said first fluid injection portion;
wherein the cup-shaped body comprises a cellulose pulp layer made of cellulose pulp, and an oxygen barrier liner attached to said cellulose pulp layer;
wherein the cup-shaped body of the capsule is obtained by moulding in a mould a dry or wet, preferably wet, cellulose pulp, and by attaching the oxygen barrier liner to the moulded cellulose pulp layer;
the method comprising:
a step wherein the thickness (T1) of said fluid injection portion is decreased with respect to the thickness (T2) of said at least a surrounding portion such as to improve the piercing of said fluid injection portion by the piercing member and to increase the stiffness of this fluid injection portion with respect to the stiffness of said surrounding portion, and
said thickness decreasing being made during the moulding process of the cup-shaped body or in a successive step by applying: a local mechanical compression only to the cellulose pulp layer of said injection portion, or to both said cellulose pulp layer and the oxygen barrier liner of said injection portion.

11. The method according to claim 10, wherein, in addition to the local mechanical compression, also an ultrasonic stiffening treatment is applied to the cellulose pulp layer of the of the injection portion, and/or also a heating treatment is applied to the oxygen barrier liner and the cellulose pulp layer of the injection portion.
